(19) United States
(12) Patent Application Publication
(10) Pub. No.: US 2025/0377071 A1
(43) Pub. Date: Dec. 11, 2025

(54) Screen Rotation Device

(71) Applicant: Illinois Tool Works Inc., Glenview, IL (US)

(72) Inventor: Dongdong Wang, Shanghai (CN)

(21) Appl. No.: 19/228,920

(22) Filed: Jun. 5, 2025

(30) Foreign Application Priority Data
Jun. 7, 2024 (CN) 2024107409658

(51) Int. Cl. F16M 11/14; F16C 11/06; F16M 11/18

(52) U.S. Cl. CPC F16M 11/14; F16C 11/0695; F16M 11/18

(57) ABSTRACT

This disclosure describes a screen rotation device that includes a rotating mechanism, a transmission mechanism, and a connecting part. The rotating mechanism has a base and a bracket. The base is attached to the screen, and the bracket is connected to the base in a way that allows it to rotate in multiple directions. The transmission mechanism is linked to the bracket and can move in a straight line to make the bracket rotate. The connecting part is also attached to the base and connected to the transmission mechanism. The screen rotation device in the present disclosure is capable of rotating multi-directionally.

### RELATED APPLICATION

The present application claims the benefit of Chinese Patent Application Nos. 2024107409658, filed Jun. 7, 2024, each titled “Screen Rotation Device,” the contents of which are hereby incorporated by reference.

### TECHNICAL FIELD

The present disclosure relates to a screen rotation device, and in particular to a screen rotation device capable of rotating in a plurality of directions.

### BACKGROUND

Vehicles are generally equipped with display screens for displaying parameters, navigation, entertainment or other functions. When using a screen, it is sometimes necessary to adjust the tilt angle of the screen to make it easier for a user to view. Therefore, the screen needs to be able to rotate in a plurality of directions to meet the user's needs.

### SUMMARY OF THE DISCLOSURE

The present disclosure relates generally to a screen rotation device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a first aspect of a screen rotation device in the present disclosure and a screen.

FIG. 1B is an exploded view of the screen rotation device and the screen in FIG. 1A.

FIG. 2A is a perspective view of a base in FIG. 1B.

FIG. 2B is a perspective view of the base in FIG. 2A, taken from another angle.

FIG. 3 is a perspective view of a bracket in FIG. 1B.

FIG. 4 is a perspective view of a connecting portion in FIG. 1B.

FIG. 5 is a perspective view of a first push rod and a second push rod in FIG. 1B.

FIG. 6 is a perspective view of a support seat in FIG. 1B.

FIG. 7 is a perspective view of a driving device in FIG. 1B.

FIG. 8A is a perspective view of the screen rotation device in FIG. 1A with the screen held in a first position.

FIG. 8B is a perspective view of the screen rotation device in FIG. 1A with the screen held in a second position.

FIG. 8C is a perspective view of the screen rotation device in FIG. 1A with the screen held in a third position.

FIG. 8D is a perspective view of the screen rotation device in FIG. 1A with the screen held in a fourth position.

FIG. 9A is a perspective view of a second aspect of the screen rotation device in the present disclosure and a screen.

FIG. 9B is an exploded view of the screen rotation device and the screen in FIG. 9A.

FIG. 10A is a perspective view of a base in FIG. 9B.

FIG. 10B is a perspective view of the base in FIG. 10A, taken from another angle.

FIG. 11 is a perspective view of a bracket in FIG. 9B.

FIG. 12 is a cross-sectional view of a rotating mechanism in FIG. 9A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a screen rotation device, including: a rotating mechanism, a transmission mechanism, and a connecting portion, the rotating mechanism including a base and a bracket, the base being connected to a screen; the bracket being rotatably connected to the base and being rotatable about a plurality of directions relative to the base; the transmission mechanism being connected to the bracket, and the transmission mechanism being configured to be able to move linearly so as to drive the bracket to rotate; and the connecting portion being rotatably connected to the base and being connected to the transmission mechanism.

In the screen rotation device as described above, the transmission mechanism includes: a first push rod and a second push rod, the first push rod and the second push rod being respectively connected to the base, the first push rod being capable of moving linearly to drive the base to rotate about a first direction, and the second push rod being capable of moving linearly to drive the base to rotate about a second direction.

In the screen rotation device as described above, the connecting portion includes a connecting ring, the connecting ring being sleeved on the base and enabling the base to rotate about a third direction relative to the connecting ring.

In the screen rotation device as described above, the first direction, the second direction and the third direction are perpendicular to one another; and the first direction and the second direction are linear directions passing through the base.

In the screen rotation device as described above, the base and the bracket are configured such that in a free state, the bracket is capable of driving the base and the screen to rotate together.

In the screen rotation device as described above, one of the base and the bracket includes a first receiving cavity, an inner wall of the first receiving cavity being a spherical surface, and the other includes a first spherical portion, the first spherical portion being able to enter the first receiving cavity and being capable of rotating about a plurality of directions in the first receiving cavity.

In the screen rotation device as described above, the connecting portion includes a main body, a first mating portion and a second mating portion, the main body including an annular portion that is larger than a semicircle, the main body being sleeved on the base, the first mating portion and the second mating portion extending outward from an outer surface of the main body respectively, and the first mating portion and the second mating portion being connected to the transmission mechanism.

In the screen rotation device as described above, one end of the first push rod includes a first push rod connecting portion, one end of the second push rod includes a second push rod connecting portion, the first mating portion is connected to the first push rod connecting portion and is capable of rotating multi-directionally relative to the first push rod connecting portion, and the second mating portion is connected to the second push rod connecting portion and is capable of rotating multi-directionally relative to the second push rod connecting portion.

In the screen rotation device as described above, one of the first mating portion and the first push rod connecting portion includes a second spherical portion, and the other includes a second receiving cavity, the second spherical portion being able to enter the second receiving cavity and being capable of rotating about a plurality of directions in the second receiving cavity; and one of the second mating portion and the second push rod connecting portion includes a third spherical portion, and the other includes a third receiving cavity, the third spherical portion being able to enter the third receiving cavity and being capable of rotating about a plurality of directions in the third receiving cavity.

In the screen rotation device as described above, the screen rotation device further includes a first actuator group, and the first actuator group is connected to the bracket and is capable of driving the bracket to rotate.

In the screen rotation device as described above, the screen rotation device further includes a second actuator group, the second actuator group being connected to the first push rod and the second push rod and being capable of driving the first push rod and the second push rod to move in a linear direction.

In the screen rotation device as described above, the screen rotation device further includes a support seat, the support seat is provided with a pair of push rod holes, and each of the pair of push rod holes is in an anti-rotation shape; and the first push rod and the second push rod are provided with a first push rod midsection and a second push rod midsection respectively, the shapes of the first push rod midsection and the second push rod midsection match the shapes of the pair of push rod holes respectively to limit rotation of the first push rod midsection and the second push rod midsection relative to the support seat, and the first push rod midsection and the second push rod midsection are able to enter and slide in the corresponding push rod holes of the support seat respectively.

In the screen rotation device as described above, the base is provided with an annular groove, the main body is arranged in the annular groove, and the first mating portion and the second mating portion extend beyond the annular groove.

In the screen rotation device as described above, the first mating portion and the second mating portion are respectively located on two diameters of a circumference where the connecting ring is located, and an included angle between the two diameters is 90 degrees.

In the screen rotation device as described above, the first push rod and the second push rod include a first screw portion and a second screw portion respectively, both of the first screw portion and the second screw portion have threads, and the first screw portion and the second screw portion respectively cooperate with corresponding threaded portions of the second actuator group to enable the first push rod and the second push rod to move in the linear direction.

In the screen rotation device as described above, the rotating mechanism further includes a ball, the bracket has a central axis, the bracket is configured to be able to rotate about the central axis, the inner wall of the first receiving cavity includes a receiving cavity recess, an outer wall of the first spherical portion includes a spherical portion recess, the receiving cavity recess and the spherical portion recess are capable of enclosing an accommodating space, the accommodating space extends, in a curved manner, along the spherical surface in a direction of the central axis of the bracket, and the ball is capable of moving in the accommodating space.

The screen rotation device in the present disclosure enables the movement of a screen in a plurality of directions. A screen adjustment device in the present disclosure has a compact structure and is suitable for a smaller installation space.

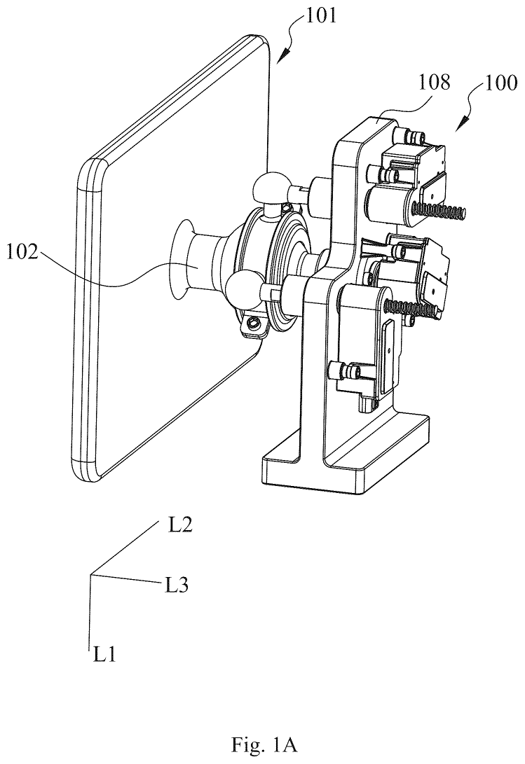

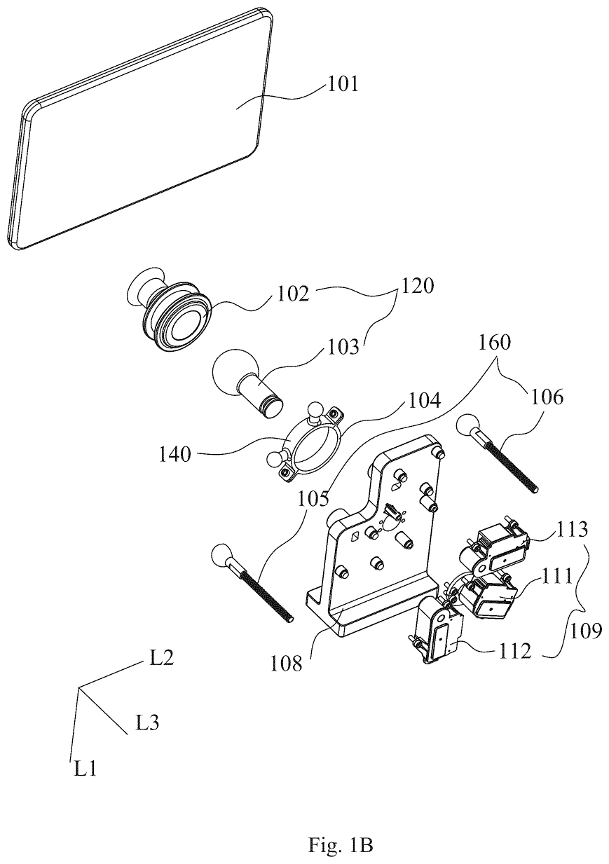

FIG. 1A is a perspective view of a first aspect of a screen rotation device in the present disclosure and a screen, and FIG. 1B is an exploded view of the screen rotation device and the screen in FIG. 1A.

As shown in FIGS. 1A and 1B, the screen rotation device 100 includes a rotating mechanism 120, a connecting portion 104, a transmission mechanism 160, a support seat 108 and a driving device 109. The rotating mechanism 120 includes a base 102 and a bracket 103. The base 102 is fixedly connected to the screen 101, that is, the base 102 is non-rotatably connected to a side of the screen 101 away from a display screen by means of welding, screw connection or integral molding. One end of the bracket 103 is rotatably connected to the base 102 and the other end passes through the support seat 108 and is connected to the driving device 109, so that the bracket 103 can be driven by the driving device 109 to rotate about a third direction L3. The transmission mechanism 160 includes a first push rod 105 and a second push rod 106. The connecting portion 104 can connect the base 102 to the first push rod 105 and to the second push rod 106. The connecting portion 104 includes a connecting ring 140. The connecting ring 140 is sleeved on the base 102 and can rotate relative to the base 102. One end of the first push rod 105 is connected to the base 102 via the connecting ring 140, and the other end passes through the support seat 108 and is connected to the driving device 109. The first push rod 105 can be driven by the driving device 109 to move along a straight line parallel to the third direction L3, so as to rotate the connecting ring 140 about a first direction L1. One end of the second push rod 106 is connected to the base 102 via the connecting ring 140, and the other end passes through the support seat 108 and is connected to the driving device 109. The second push rod 106 can be driven by the driving device 109 to move along a straight line parallel to the third direction L3, so as to rotate the connecting ring 140 about a second direction L2.

In one aspect of the present disclosure, the first direction L1, the second direction L2 and the third direction L3 are perpendicular to each other, all in a linear direction passing through the base 102. The screen rotation device 100 can be rotated about three directions, so as to be adjusted to an appropriate angle.

The driving device 109 includes a first actuator 111, a second actuator 112, and a third actuator 113. The first actuator is configured to drive the bracket 103 to rotate, the second actuator 112 is configured to drive the first push rod 105 to move, and the third actuator 113 is configured to drive the second push rod 106 to move. The first actuator 111 forms a first actuator group, and the second actuator 112 and the third actuator 113 form a second actuator group.

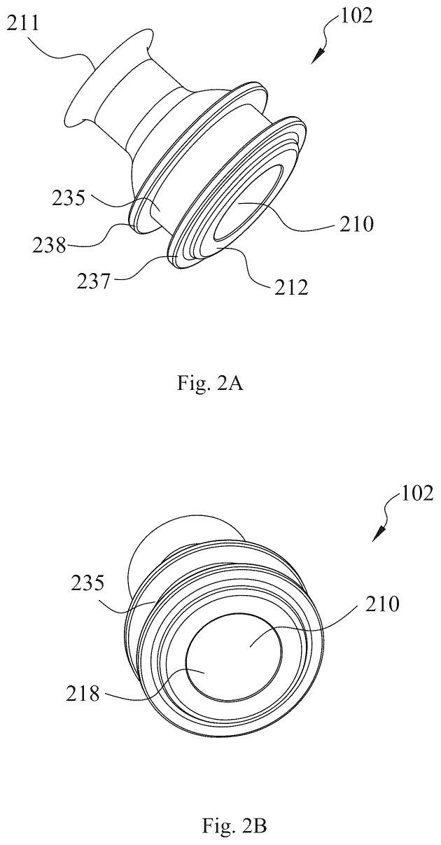

FIG. 2A is a perspective view of the base in FIG. 1B, and FIG. 2B is a perspective view of the base in FIG. 2A, taken from another angle. As shown in FIGS. 2A and 2B, the base 102 extends in an axial direction and has a first end 211 and a second end 212. The first end 211 is fixedly connected to the screen 101, and the second end 212 is rotatably connected to the bracket 103. The second end 212 has an opening 218, and a first receiving cavity 210 recessed inwardly from the opening 218. The first receiving cavity 210 has a spherical inner surface. In some examples of the present disclosure, the first receiving cavity 210 has a spherical shape that extends beyond a hemisphere, and the base 102 is a structure assembled from two parts, to facilitate mounting of the bracket 103 into the first receiving cavity 210.

The base 102 further includes a first flange 237 and a second flange 238 extending outwardly in a radial direction from an outer surface of the base 102. An annular groove 235 is formed between the first flange 237 and the second flange 238. The annular groove 235 is configured to receive the connecting ring 140 and limit the movement of the connecting ring 140 in the axial direction of the base 102. In another aspect of the present disclosure, the annular groove 235 is an annular groove recessed inwardly from the outer surface of the base 102.

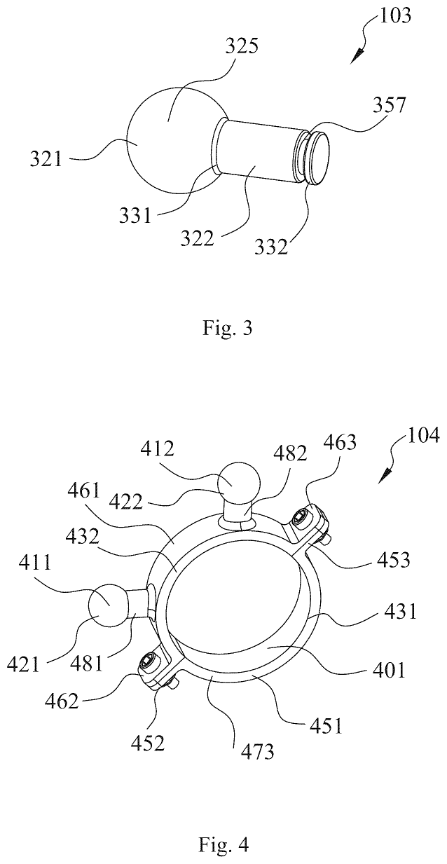

FIG. 3 is a perspective view of the bracket in FIG. 1B. As shown in FIG. 3, the bracket 103 includes a head 321 and a rod portion 322. The rod portion 322 is substantially cylindrical and extends in an axial direction, and the rod portion 322 has a first axial end 331 connected to the head 321 and a second axial end 332 connected to the driving device 109. The second axial end 332 has a recess 357. The recess 357 is substantially annular and extends in a circumferential direction. The head 321 includes a first spherical portion 325 with a spherical outer contour. The shape of the first spherical portion 325 matches the shape of the first receiving cavity 210, so that the first spherical portion 325 can enter the first receiving cavity 210 and can rotate in the first receiving cavity 210.

FIG. 4 is a perspective view of the connecting portion in FIG. 1B. As shown in FIG. 4, the connecting ring 140 includes a main body 401, a first mating portion 411, and a second mating portion 412. The main body 401 is substantially a circular ring. The main body 401 is formed by a first portion 431 and a second portion 432 connected to each other. The first portion 431 includes a semi-annular portion 451 in the shape of a semicircular ring and a pair of extension portions 452 and 453, the extension portions 452 and 453 extending from two ends of the semi-annular portion 451. The second portion 432 includes a semi-annular portion 461 in the shape of a semicircular ring and a pair of extension portions 462 and 463, the extension portions 462 and 463 extending from two ends of the semi-annular portion 461. The extension portion 452 and the extension portion 462, and the extension portion 453 and the extension portion 463 are connected to each other via screws or the like, so that the semi-annular portion 451 and the semi-annular portion 461 form a complete annular portion 473. An inner diameter of the annular portion 473 matches an outer diameter of the annular groove 235, and a width of the annular portion 473 in the axial direction matches a width of the annular groove 235 in the axial direction.

The first mating portion 411 includes a rod portion 481 and a second spherical portion 421. The rod portion 481 has one end connected to an outer side of the main body 401, and the other end connected to the second spherical portion 421, and an outer surface of the second spherical portion 421 has a spherical contour. The second mating portion 412 includes a rod portion 482 and a third spherical portion 422. The rod portion 482 has one end connected to the outer side of the main body 401, and the other end connected to the third spherical portion 422, and an outer surface of the third spherical portion 422 has a spherical contour. The extension directions of the first mating portion 411 and the second mating portion 412 are substantially perpendicular to each other, and both pass through a central axis of a circumference defined by an inner surface of the annular portion 473.

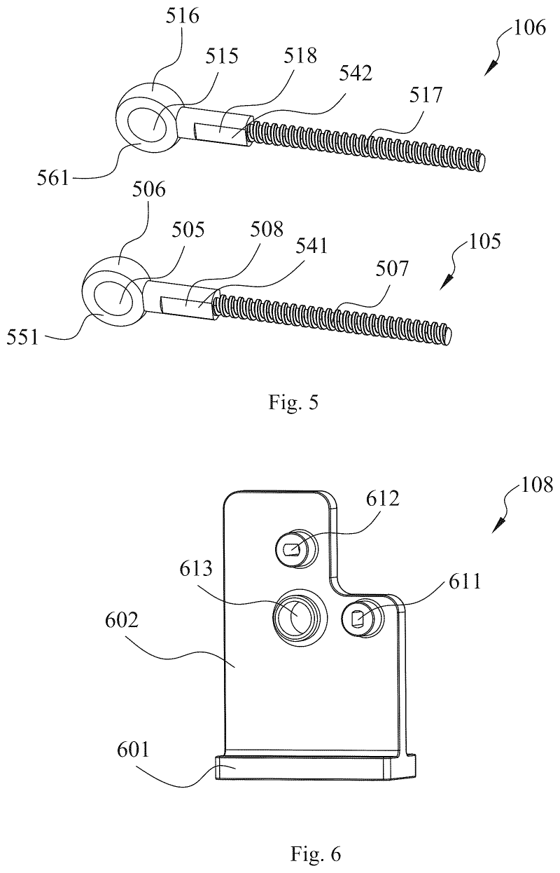

FIG. 5 is a perspective view of the first push rod and the second push rod in FIG. 1B. In the present disclosure, the first push rod 105 and the second push rod 106 are of the same structure, which is described below by taking the first push rod as an example.

As shown in FIG. 5, the first push rod 105 includes a first screw portion 507, a first push rod midsection 508, and a first push rod head 506. Two ends of the first push rod midsection 508 are connected to the first screw portion 507 and the first push rod head 506, respectively. The first screw portion 507 has an external thread which can mate with a gear mechanism of the driving device. The first push rod head 506 has a second receiving cavity 505, and the second receiving cavity 505 is substantially hemispherical in shape matching the second spherical portion 421 of the first mating portion 411. The first push rod head 506 forms a first push rod connecting portion 551, and thus can be connected to the connecting ring 140. The first push rod midsection 508 includes a pair of recesses 541. The pair of recesses 541 are recessed inwardly from an outer surface of the first push rod midsection 508 and extend in an axial direction to an end of the first push rod midsection 508 close to the first screw portion 507, whereby the outer contour of the first push rod midsection 508 forms an anti-rotation non-cylindrical shape, to mate with a corresponding portion of the support seat 108. In one aspect of the present disclosure, the cross-section of the first push rod midsection 508 has an oblong shape having a pair of oppositely arranged straight sides and a pair of oppositely arranged arc-shaped sides.

Similarly, the second push rod 106 includes a second screw portion 517, a second push rod midsection 518, and a second push rod head 516. Two ends of the second push rod midsection 518 are connected to the second screw portion 517 and the second push rod head 516, respectively. The second screw portion 517 has an external thread which can mate with a gear mechanism of the driving device. The second push rod head 516 has a third receiving cavity 515, and the third receiving cavity 515 is substantially hemispherical in shape matching the third spherical portion 422 of the second mating portion 412. The second push rod head 516 forms a second push rod connecting portion 561, and thus can be connected to the connecting ring 140. The second push rod midsection 518 includes a pair of recesses 542. The pair of recesses 542 are recessed inwardly from an outer surface of the second push rod midsection 518 and extend in an axial direction to an end of the second push rod midsection 518 close to the second screw portion 517, whereby the outer contour of the second push rod midsection 518 forms an anti-rotation non-cylindrical shape, to mate with a corresponding portion of the support seat 108. In one aspect of the present disclosure, the cross-section of the second push rod midsection 518 has an oblong shape having a pair of oppositely arranged straight sides and a pair of oppositely arranged arc-shaped sides.

FIG. 6 is a perspective view of the support seat in FIG. 1B. As shown in FIG. 6, the support seat 108 includes a bottom portion 601 and a support plate 602, the bottom portion 601 being connected to the support plate 602. The support plate 602 includes a pair of push rod holes 611 and 612 extending through the support plate 602, and a bracket hole 613. The cross-sections of the push rod holes 611 and 612 match the cross-sections of the first push rod midsection 508 and the second push rod midsection 518 in terms of shape. The first push rod midsection 508 and the second push rod midsection 518 can be inserted into the push rod holes 611 and 612, are constrained by the shapes of the push rod holes 611 and 612, and cannot rotate in the push rod holes 611 and 612.

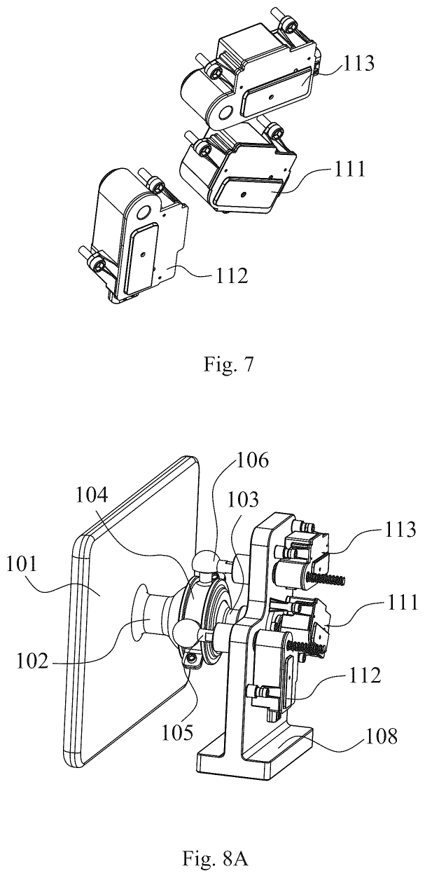

FIG. 7 is a perspective view of the driving device in FIG. 1B. As shown in FIGS. 1B and 7, the driving device 109 includes a first actuator 111, a second actuator 112, and a third actuator 113. The first actuator 111 is fixedly connected to the bracket 103 and can drive the bracket 103 to rotate. The second actuator 112 and the third actuator 113 are respectively provided with gear mechanisms capable of meshing with the first screw portion 507 of the first push rod 105 and the second screw portion 517 of the second push rod 106, respectively, so as to drive the first push rod 105 and the second push rod 106 to move in a linear direction.

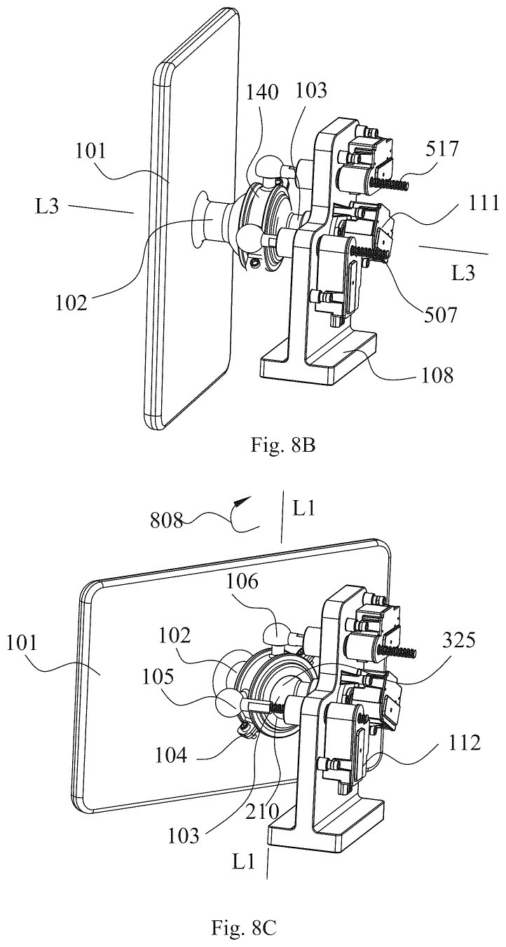

FIG. 8A is a perspective view of the screen rotation device in FIG. 1A with the screen held in a first position, FIG. 8B is a perspective view of the screen rotation device in FIG. 1A with the screen held in a second position, FIG. 8C is a perspective view of the screen rotation device in FIG. 1A with the screen held in a third position, and FIG. 8D is a perspective view of the screen rotation device in FIG. 1A with the screen held in a fourth position.

Referring to FIGS. 1A-8A, the first actuator 111, the second actuator 112 and the third actuator 113 are mounted on one side of the support seat 108, and the screen 101 is located on the other side of the support seat 108. The screen 101 is connected to the bracket 103 via the base 102. The bracket 103 passes through the support seat 108 and is connected to the first actuator. The connecting ring 140 is sleeved on the base 102. The first push rod 105 and the second push rod 106 each have one end connected to the connecting ring 140 and the other end passing through the support seat 108 and connected to the second actuator 112 and the third actuator 113. The first actuator 111, the second actuator 112 and the third actuator 113 can control the multi-directional rotation of the screen 101.

The second axial end 332 of the bracket 103 passes through the bracket hole 613 of the support seat 108 and is connected to the first actuator 111. The first actuator 111 can drive the bracket 103 to rotate about the central axis of the bracket 103 (i.e., the third direction L3). The first spherical portion 325 of the bracket 103 enters the first receiving cavity 210 of the base 102 and is in contact with an inner wall of the first receiving cavity 210. There is a certain friction force between the first spherical portion 325 and the first receiving cavity 210, and when the bracket 103 and the base 102 are not subjected to external force, or the external force is relatively small, the bracket 103 can drive the base 102 to rotate together. When the first actuator 111 drives the bracket 103 to rotate, the base 102 rotates along with the bracket 103, so as to drive the screen 101 to rotate, so that the screen 101 can rotate about the third direction L3.

When an external force is applied to the base 102 and overcomes the friction force between the first spherical portion 325 and the first receiving cavity 210, the first spherical portion 325 and the first receiving cavity 210 can rotate relative to each other, and the first spherical portion 325 can rotate multi-directionally in the first receiving cavity 210. That is, the bracket 103 and the base 102 form a universal rotating mechanism, and the base 102 can rotate in a plurality of directions relative to the bracket 103 under the action of an external force.

The connecting ring 140 is sleeved on the base 102 so that the base 102 can rotate relative to the connecting ring 140. The first mating portion 411 and the second mating portion 412 of the connecting ring 140 extend beyond the annular groove 235 so as to protrude from the outer surface of the base 102. When the first actuator 111 drives the bracket 103 to rotate, the base 102 is driven by the bracket 103 to rotate relative to the connecting ring 140, and the connecting ring 140 remains stationary relative to the support seat 108.

The second spherical portion 421 of the connecting ring 140 is located in the second receiving cavity 505 of the first push rod 105, so that the connecting ring 140 is connected to the first push rod 105. A distal end of the first screw portion 507 of the first push rod 105 passes through the push rod hole 611 of the support seat 108 and is connected to the second actuator 112. The first push rod midsection 508 is located in the push rod hole 611 and matches the shape of the push rod hole 611, so that the first push rod 105 can move in the push rod hole 611 but cannot rotate relative to the support seat 108. The second actuator 112 is provided with a gear mating with the first screw portion 507. When the gear rotates, the first push rod 105 moves linearly in an axial direction of the first push rod 105.

Similarly, the third spherical portion 422 of the connecting ring 140 is located in the third receiving cavity 515 of the second push rod 106, so that the connecting ring 140 is connected to the second push rod 106. A distal end of the second screw portion 517 of the second push rod 106 passes through the push rod hole 612 of the support seat 108 and is connected to the third actuator 113. The second push rod midsection 518 is located in the push rod hole 612 and matches the shape of the push rod hole 612, so that the second push rod 106 can move in the push rod hole 612 but cannot rotate relative to the support seat 108. The third actuator 113 is provided with a gear mating with the second screw portion 517. When the gear rotates, the second push rod 106 moves linearly in an axial direction of the second push rod 106.

In the present disclosure, the first push rod 105 and the second push rod 106 are arranged in parallel, and the first push rod 105 and the second push rod 106 are parallel to the central axis of the bracket 103, that is, parallel to the third direction L3. The first push rod 105 and the second push rod 106 can be driven to move in a linear direction parallel to the third direction L3. The extension directions of the first mating portion 411 and the second mating portion 412 of the connecting ring 140 are substantially perpendicular to each other and both pass through a central axis of a circumference defined by an inner surface of the annular portion 473. That is, the second spherical portion 421 and the third spherical portion 422 are located at two ends of a ¼ arc segment of the annular portion 473. The second actuator 112 can drive the first push rod 105 to move linearly, and the first push rod 105 drives the connecting ring 140 to rotate about the first direction L1. The first direction is substantially the extension direction of the central axis of the second mating portion 412, that is, the direction of a connecting line passing through the center of the third spherical portion 422 and the center of the first spherical portion 325. The third actuator 113 can drive the second push rod 106 to move linearly, and the second push rod 106 drives the connecting ring 140 to rotate about the second direction L2. The second direction is substantially the extension direction of the central axis of the first mating portion 411, that is, the direction of a connecting line passing through the center of the second spherical portion 421 and the center of the first spherical portion 325.

When the screen 101 is rotated from the first position shown in FIG. 8A to the second position shown in FIG. 8B, the first actuator 111 drives the bracket 103 to rotate about the third direction L3. There is a certain friction force between the bracket 103 and the base 102, and the base 102 rotates together with the bracket 103, so that the screen 101 rotates together with the base 102 about the third direction L3. During the process shown in FIG. 8A to FIG. 8B, the connecting ring 140, the first push rod 105, the second push rod 106, and the support seat 108 all remain in place. The friction force between the connecting ring 140 and the base 102 is less than the friction force between the bracket 103 and the base 102, and the base 102 rotates relative to the connecting ring 140 but not relative to the bracket 103.

When the screen 101 is rotated from the first position shown in FIG. 8A to the third position shown in FIG. 8C, the second actuator 112 drives the first push rod 105 to move in a linear direction toward the screen 101. In this way, the first push rod 105 pushes the second spherical portion 421 of the connecting ring 140 to move, and the connecting ring 140 drives the base 102 to produce a movement tendency. Since the first spherical portion 325 of the bracket 103 is located in the first receiving cavity 210 of the base 102, the base 102 cannot be disengaged from the bracket 103, and the base 102 is thus rotated relative to the bracket 103 about the first direction L1, causing the screen 101 to rotate along the arrow 808 about the first direction L1. During the above-mentioned movement, the second spherical portion 421 also undergoes a certain angle of rotation relative to the second receiving cavity 505, and the bracket 103, the second push rod 106 and the support seat 108 all remain in place. The second actuator 112 may also drive the first push rod 105 to move in a direction away from the screen 101, thereby causing the screen 101 to rotate about the first direction L1 in a direction opposite to that indicated by the arrow 808.

When the screen 101 is rotated from the first position shown in FIG. 8A to the fourth position shown in FIG. 8D, the third actuator 113 drives the second push rod 106 to move in a linear direction toward the screen 101. In this way, the second push rod 106 pushes the third spherical portion 422 of the connecting ring 140 to move, and the connecting ring 140 drives the base 102 to produce a movement tendency. Since the first spherical portion 325 of the bracket 103 is located in the first receiving cavity 210 of the base 102, the base 102 cannot be disengaged from the bracket 103, and the base 102 is thus rotated relative to the bracket 103 about the second direction L2, causing the screen 101 to rotate along the arrow 809 about the second direction L2. During the above-mentioned movement, the third spherical portion 422 also undergoes a certain angle of rotation relative to the third receiving cavity 515, and the bracket 103, the first push rod 105 and the support seat 108 all remain in place. The third actuator 113 may also drive the second push rod 106 to move in a direction away from the screen 101, thereby causing the screen 101 to rotate about the second direction L2 in a direction opposite to that indicated by the arrow 809.

As shown in FIGS. 8A-8D, in the present disclosure, the screen rotation device can drive the screen to rotate about three directions. By combining the rotations about these three directions, the screen can be adjusted to a plurality of angles. In the present disclosure, the rotation of the screen in the three directions can be performed separately or simultaneously. In one aspect of the present disclosure, the first actuator 111, the second actuator 112 and the third actuator 113 can be set in an unlocked mode, and an operator can manually adjust the screen by applying an external force to the screen 101.

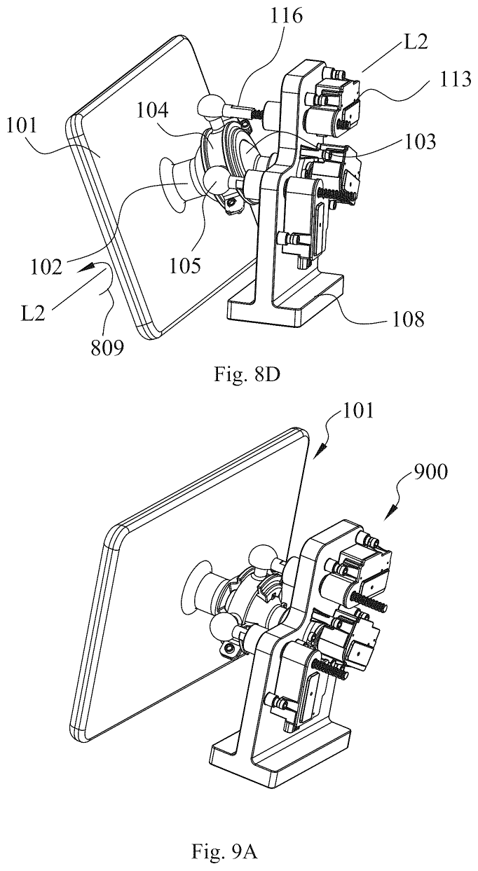

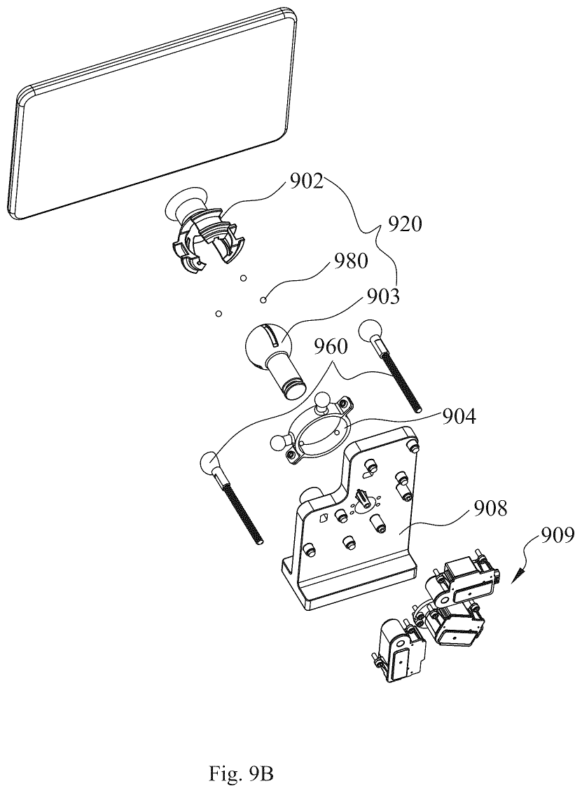

FIG. 9A is a perspective view of a second aspect of the screen rotation device in the present disclosure and the screen, and FIG. 9B is an exploded view of the screen rotation device and the screen in FIG. 9A. The aspect shown in FIGS. 9A and 9B is similar to the aspect shown in FIG. 1A, except that the rotating mechanism has a different structure.

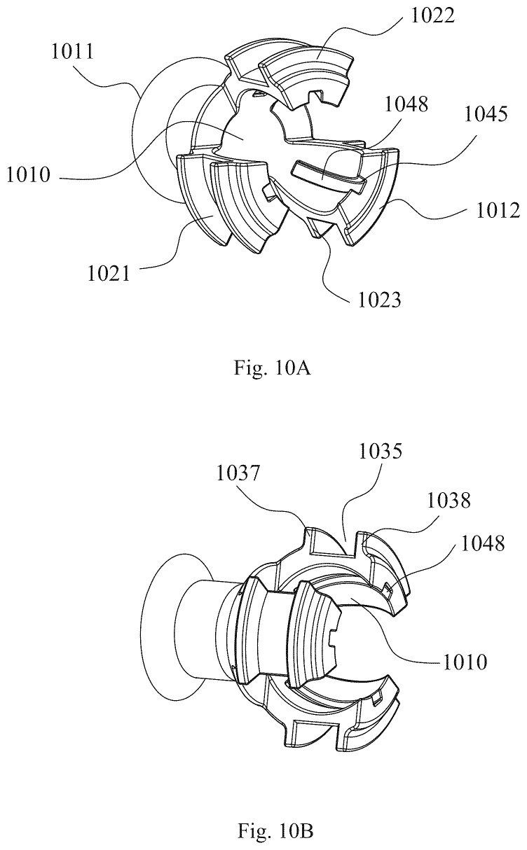

Similar to FIG. 1A, the screen rotation device 900 shown in FIG. 9A includes a rotating mechanism 920, a connecting portion 904, a transmission mechanism 960, a support seat 908 and a driving device 909. The connecting portion 904, the transmission mechanism 960, the support seat 908 and the driving device 909 are the same as those in the aspect shown in FIG. 1A, and the rotating mechanism 920 differs from the rotating mechanism 120. As shown in FIGS. 9A and 9B, the rotating mechanism 920 includes a base 902, a bracket 903, and balls 980. The balls 980 are arranged between the bracket 903 and the base 902, and the mating relationship of the rotating mechanism 920 will be described below with reference to FIGS. 10A-12.

FIG. 10A is a perspective view of the base in FIG. 9B, and FIG. 10B is a perspective view of the base in FIG. 10A, taken from another angle. As shown in FIGS. 10A and 10B, the base 902 extends in an axial direction and has a first end 1011 and a second end 1012. The first end 1011 is fixedly connected to the screen 101, and the second end 1012 is rotatably connected to the bracket 903. The second end 1012 includes three side portions 1021, 1022 and 1023. The three side portions 1021, 1022 and 1023 enclose a first receiving cavity 1010, and inner walls of the three side portions 1021, 1022 and 1023 are parts of a spherical surface. That is, the first receiving cavity 1010 has a spherical inner surface. Distal ends of the three side portions 1021, 1022 and 1023 enclose an opening 1045, to facilitate the mounting of the bracket 903. There is a spacing between adjacent ones of the three side portions 1021, 1022 and 1023, so that each side portion has a certain elasticity and is capable of deformation, facilitating connection with the bracket 903.

The base 902 further includes a first flange 1037 and a second flange 1038 extending outwardly in a radial direction from an outer surface of the base 902. An annular groove 1035 is formed between the first flange 1037 and the second flange 1038. The annular groove 1035 is configured to receive the connecting portion and limit the movement of the connecting portion in the axial direction of the base 902.

The inner wall of each of the three side portions 1021, 1022 and 1023 has a receiving cavity recess 1048. The receiving cavity recess 1048 is substantially strip-shaped and extends along a spherical surface in the axial direction of the base. That is, the receiving cavity recess 1048 extends along a direction from the distal end of the respective side portion to a proximal end of the side portion. The size of the receiving cavity recess 1048 matches the size of the ball 980 such that the ball 980 can be received in the receiving cavity recess 1048.

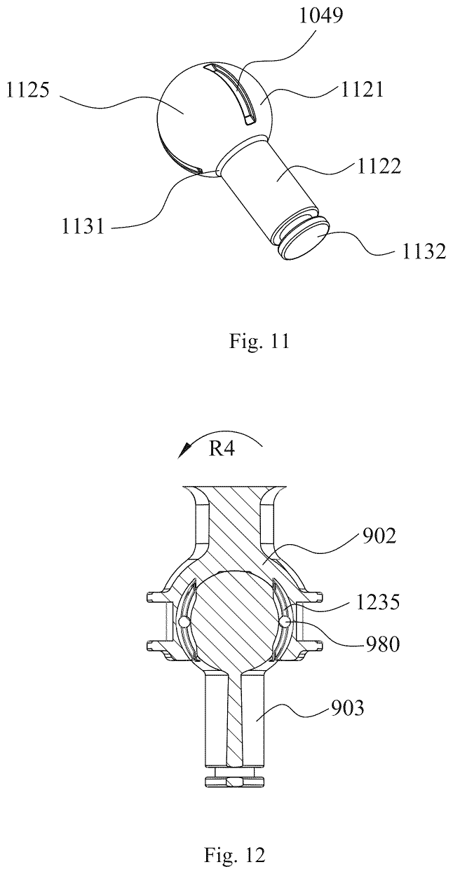

FIG. 11 is a perspective view of the bracket in FIG. 9B. As shown in FIG. 11, the bracket 903 includes a head 1121 and a rod portion 1122. The rod portion 1122 is substantially cylindrical and extends in an axial direction, and the rod portion 1122 has a first axial end 1131 connected to the head 1121 and a second axial end 1132 connected to the driving device 909. The head 1121 includes a first spherical portion 1125 with a spherical outer contour. The shape of the first spherical portion 1125 matches the shape of the first receiving cavity 1010 so that the first spherical portion 1125 can enter the first receiving cavity 1010 and can rotate in the first receiving cavity 1010.

The first spherical portion 1125 includes three spherical portion recesses 1049. The spherical portion recess 1049 is substantially strip-shaped and extends along the sphere in the axial direction of the bracket 903. That is, the spherical portion recess 1049 extends along the spherical surface of the first spherical portion from a position close to the rod portion 1122 toward a direction away from the rod portion 1122. The size of the spherical portion recess 1049 matches the size of the receiving cavity recess 1048. When the central axis of the bracket 903 coincides with the central axis of the base 902, the spherical portion recess 1049 can be substantially aligned with the receiving cavity recess 1048.

FIG. 12 is a cross-sectional view of the rotating mechanism in FIG. 9A. As shown in FIG. 12, the spherical portion recess 1049 and the receiving cavity recess 1048 can enclose an accommodating space 1235, and the ball 980 is located in the accommodating space 1235. The ball 980 mates with the accommodating space 1235 such that the first spherical portion 1125 can rotate relative to the first receiving cavity only in the direction of the accommodating space 1235, i.e. rotating in the same direction as or opposite to a fourth direction R4 as indicated by the arrow in FIG. 12. When the bracket 903 rotates about the central axis in the axial direction of the bracket 903, the first spherical portion 1125 can drive the base 902 to rotate together by means of the ball 980. That is, when the bracket 903 is rotated about the third direction, the base 902 cannot rotate relative to the bracket 903, but can only rotate together with the bracket 903.

The aspect shown in FIGS. 9A-12 can achieve the same technical effect as the aspect shown in FIG. 1A. In the aspect shown in FIG. 9A, when the bracket 903 drives the base 902 to rotate together, relative sliding between the bracket 903 and the base 902 is less likely to occur.

Although the present disclosure is described with reference to the examples of the aspects outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Therefore, various changes may be made without departing from the spirit or scope of the present disclosure. Therefore, the present disclosure is intended to encompass all known or earlier disclosed alternatives, modifications, variations, improvements. and/or substantial equivalents.

What is claimed is:

1. A screen rotation device, comprising:
a rotating mechanism comprising a base and a bracket, the base being connected to a screen; the bracket being rotatably connected to the base and being rotatable about a plurality of directions relative to the base;
a transmission mechanism, the transmission mechanism being connected to the bracket, and the transmission mechanism being configured to be able to move linearly so as to drive the bracket to rotate; and
a connecting portion, the connecting portion being rotatably connected to the base and being connected to the transmission mechanism.

2. The screen rotation device of claim 1, wherein
the transmission mechanism comprises: a first push rod and a second push rod, the first push rod and the second push rod being connected to the base respectively, the first push rod being capable of moving linearly to drive the base to rotate about a first direction, and the second push rod being capable of moving linearly to drive the base to rotate about a second direction.

3. The screen rotation device of claim 2, wherein
the connecting portion comprises a connecting ring, the connecting ring being sleeved on the base and enabling the base to rotate about a third direction relative to the connecting ring.

4. The screen rotation device of claim 3, wherein
the first direction, the second direction and the third direction are perpendicular to one another; and the first direction and the second direction are linear directions passing through the base.

5. The screen rotation device of claim 1, wherein
the base and the bracket are configured such that in a free state, the bracket is capable of driving the base and the screen to rotate together.

6. The screen rotation device of claim 5, wherein
one of the base and the bracket comprises a first receiving cavity, an inner wall of the first receiving cavity being a spherical surface, and the other comprises a first spherical portion, the first spherical portion being able to enter the first receiving cavity and being capable of rotating about a plurality of directions in the first receiving cavity.

7. The screen rotation device of claim 2, wherein
the connecting portion comprises a main body, a first mating portion and a second mating portion, the main body comprising an annular portion that is larger than a semicircle, the main body being sleeved on the base, the first mating portion and the second mating portion extending outward from an outer surface of the main body respectively, and the first mating portion and the second mating portion being connected to the transmission mechanism.

8. The screen rotation device of claim 7, wherein
one end of the first push rod comprises a first push rod connecting portion, one end of the second push rod comprises a second push rod connecting portion, the first mating portion is connected to the first push rod connecting portion and is capable of rotating multi-directionally relative to the first push rod connecting portion, and the second mating portion is connected to the second push rod connecting portion and is capable of rotating multi-directionally relative to the second push rod connecting portion.

9. The screen rotation device of claim 8, wherein
one of the first mating portion and the first push rod connecting portion comprises a second spherical portion, and the other comprises a second receiving cavity, the second spherical portion being able to enter the second receiving cavity and being capable of rotating about a plurality of directions in the second receiving cavity; and
one of the second mating portion and the second push rod connecting portion comprises a third spherical portion, and the other comprises a third receiving cavity, the third spherical portion being able to enter the third receiving cavity and being capable of rotating about a plurality of directions in the third receiving cavity.

10. The screen rotation device of claim 1,
further comprising a first actuator group, wherein the first actuator group is connected to the bracket and is capable of driving the bracket to rotate.

11. The screen rotation device of claim 2,
further comprising a second actuator group, wherein the second actuator group is connected to the first push rod and the second push rod, and is capable of driving the first push rod and the second push rod to move in a linear direction.

12. The screen rotation device of claim 2, wherein
the screen rotation device further comprises a support seat, the support seat is provided with a pair of push rod holes, and each of the pair of push rod holes is in an anti-rotation shape; and
the first push rod and the second push rod are provided with a first push rod midsection and a second push rod midsection respectively, the shapes of the first push rod midsection and the second push rod midsection match the shapes of the pair of push rod holes respectively to limit rotation of the first push rod midsection and the second push rod midsection relative to the support seat, and the first push rod midsection and the second push rod midsection are respectively able to enter and slide in the corresponding push rod holes of the support seat.

13. The screen rotation device of claim 7, wherein
the base is provided with an annular groove, the main body is arranged in the annular groove, and the first mating portion and the second mating portion extend beyond the annular groove.

14. The screen rotation device of claim 3, wherein
the first mating portion and the second mating portion are respectively located on two diameters of a circumference where the connecting ring is located, and an included angle between the two diameters is 90 degrees.

15. The screen rotation device of claim 11, wherein
the first push rod and the second push rod comprise a first screw portion and a second screw portion respectively, both of the first screw portion and the second screw portion have threads, and the first screw portion and the second screw portion respectively cooperate with corresponding threaded portions of the second actuator group to enable the first push rod and the second push rod to move in the linear direction.

16. The screen rotation device of claim 6, wherein
the rotating mechanism further comprises a ball, the bracket has a central axis, the bracket is configured to be able to rotate about the central axis, the inner wall of the first receiving cavity comprises a receiving cavity recess, an outer wall of the first spherical portion comprises a spherical portion recess, the receiving cavity recess and the spherical portion recess are capable of enclosing an accommodating space, the accommodating space extends, in a curved manner, along the spherical surface in a direction of the central axis of the bracket, and the ball is capable of moving in the accommodating space.
